(19) United States
(12) Patent Application Publication
(10) Pub. No.: US 2011/0171487 A1
(43) Pub. Date: Jul. 14, 2011

(54) METHOD FOR MAKING A PART MADE OF A COMPOSITE MATERIAL WITH A METAL MATRIX

(75) Inventors: Guillaume Ruckert, Fiquefleur-equainville (FR); Thiery Le Docte, Le Havre (FR); Vijay Andre, Le Havre (FR); Edmond Szkolnik, Anglesqueville L'Esneval (FR)

(73) Assignee: AIRCELLE, Gonfreville L'Orcher (FR)

(21) Appl. No.: 13/119,203

(22) PCT Filed: Apr. 3, 2009
(86) PCT No.: PCT/FR09/50575

§ 371 Date: Mar. 16, 2011

(30) Foreign Application Priority Data
Sep. 17, 2008 (FR) 08/05096

(51) Int. Cl. B32B 5/16; B32B 37/02; B32B 37/06; B32B 37/10; B32B 38/00; B32B 15/00

(52) U.S. Cl. 428/615; 156/60; 156/245; 442/63

(57) ABSTRACT

The invention relates to a method for making a part made of a composite material with a metal matrix, characterised in that the method includes the steps of: providing, on a preform of the part to be made, at least one assembly of reinforcing fibres, said fibres being previously coated with at least one metal or metal alloy; heating the assembly to a temperature sufficient for diffusing the metal particles surrounding the fibre; after cooling, releasing the part made of the preform and withdrawing the latter.

### TECHNICAL FIELD The present invention relates to a method for making a part made from a composite material with a metal matrix.

### BACKGROUND

The high temperatures output from a turbojet engine require the use of metal materials resistant to high temperatures. In particular for temperatures above 600° C., the use of nickel-based alloys becomes necessary to bear the thermal and mechanical loads. Indeed, the mechanical aspect of most other metal alloys is greatly decreased in these temperature ranges.

One of the main drawbacks of these nickel-based alloys, such as Inconel 718, Inconel 625, or Waspaloy™, is a high density. Thus, for fine structures, the mass decrease is limited by the manufacturing conditions.

Mass gain is a major objective in aeronautic construction and there is therefore always a need for materials combining a low density with high thermal and mechanical properties.

One solution is to use composite materials with a metal matrix.

The addition of ceramic charges, such as long or short fibers, with particular charges, etc., makes it possible to increase the mechanical characteristics of the metal materials, in particular in the high temperature field. At constant mechanical performances, these ceramic charges also make it possible to extend the usage ranges of certain metal materials, such as titanium alloys, by several tens of degrees.

The placement of ceramic charges is delicate and conditions the behavior of the composite structure. The use of composite metal matrix (CMM) materials therefore depends greatly on manufacturing conditions.

A number of documents describe methods for manufacturing CMM elements. However, the forming of these materials to form the final piece is delicate.

Document U.S. Pat. No. 5,511,604 describes a method for making an element from a composite material with a metal matrix. However, the forming of the final piece is done by machining the composite block formed.

Document JP 2004-192792 also describes a CMM plate. The forming of the plates to produce the final piece, such as a jet nozzle for example, remains difficult.

Document US 2005/0136256 describes a CMM having a particular composition made, in particular, in the form of leaves.

Document WO 2005/054536 describes a CMM using glass fibers, but does not describe a method for making a part.

In order to offset the forming problem, it is possible to use a support for the fibers.

Thus, document GB 2 324 102 describes a method for making a CMM element, said element having a symmetry axis of revolution. To that end, the ceramic fibers are wound on a mandrel before projection of molten metal. This method is, however, limited to parts having a symmetry axis of revolution, the mandrel being driven in rotation. The mandrel having to be driven in rotation, such a method has limitations in the production of parts with large dimensions, such as nozzles, for example.

Moreover, the quantity of metal on the fibers, their spacing as well as the final porosity are difficult to control. The orientation of the fibers also cannot be controlled since they must be wound around the mandrel. However, a number of mechanical properties of the composite materials depend on the orientation of the fibers.

There is therefore a need for a method allowing production flexibility, adaptable to numerous part geometries while being compatible with aeronautical construction requirements and allowing mastery of the orientation of the ceramic fibers.

### BRIEF SUMMARY

To that end, the present invention relates to a method for making a part from a composite material with a metal matrix characterized in that it comprises the following steps:
providing, on a preform of the part to be made, at least one assembly of reinforcing fibers, said fibers being previously coated with at least one metal or metal alloy,
heating the assembly to a temperature sufficient for diffusing the metal particles surrounding the fiber;
after cooling, releasing the part made of the preform and withdrawing the latter.

Thus, by providing previously coated fibers on a preform, it is possible to make parts with complex shapes from composite material with a metal matrix while precisely controlling the orientation of the fibers, their spacing and distribution.

Moreover, the fibers being previously coated, the metal coatings of the different fibers can be easily brought into contact, which imparts better homogeneity of the metal matrix after heat treatment thereof and decreases the risks of porosity and of zones without metal that must be corrected in a subsequent step.

Advantageously, the method includes a step for pre-coating the fibers. This pre-coating may, for example, be done by passing the fibers in a bath of the desired metal or molten alloy.

Advantageously, the method comprises a step for compression of the molten metal between the mold and the preform. However, due to the possibility of bringing the metal coatings of the fibers into close contact, the compression forces making it possible to ensure good diffusion of the metal after melting thereof are reduced.

Preferably, the compression step takes place during the diffusion step of the metal.

Advantageously, the compression step is done by heat expansion of the preform, in particular by replacing a hot isostatic compaction (HIC). This is made possible by the fact that the necessary compression forces are greatly reduced.

According to various alternative or complementary embodiments, at least part of the fibers assumes the form of at least one woven strip, the strip being able to comprise particular charges.

Advantageously, the preform is provided with spurs so as to make a skin made from a composite material with a perforated metal matrix. For practical reasons, the forming may give rise to a solid structure pierced later, for example by water jet, laser, punching . . .

These spurs may in particular be retractable or dissolvable thermally or chemically.

Examples of materials that can be used for the fibers include in particular silicon carbide (SiC), carbon, aluminum, boron nitride (BN). Metal fibers, such as boron fibers, can also be used.

The metal matrix may, for example, be made up of alloys of aluminum, titanium, steels, or superalloys.

### BRIEF DESCRIPTION OF THE DRAWINGS

The implementation of the invention will be understood using the detailed description provided below with regard to the appended drawing, in which:

FIG. 1 is a diagrammatic illustration in transverse cross-section of a pre-coated fiber,

FIG. 2 is a diagrammatic illustration of an example of the arrangement of pre-coated fibers,

FIG. 3 is a diagrammatic illustration of a preform of an element of a turbojet engine nacelle jet nozzle, said preform being according to the method of the invention, covered with previously coated fibers as shown in FIG. 1 and according to the example arrangement of FIG. 2.

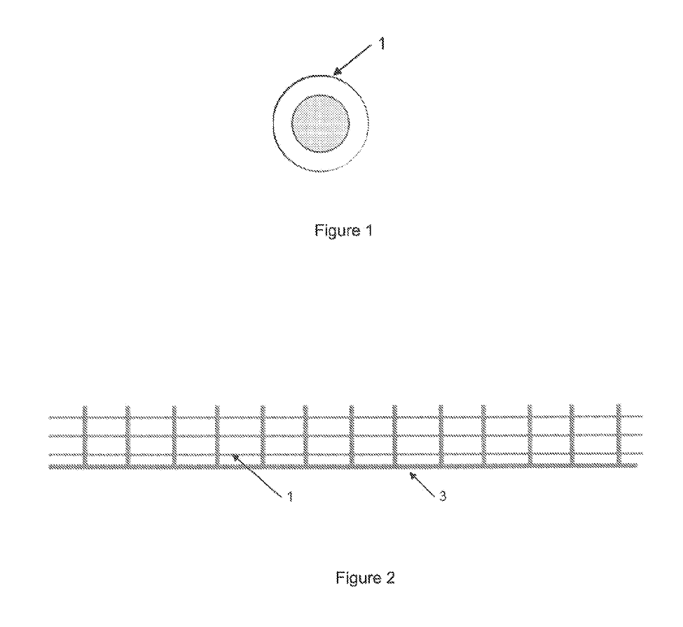

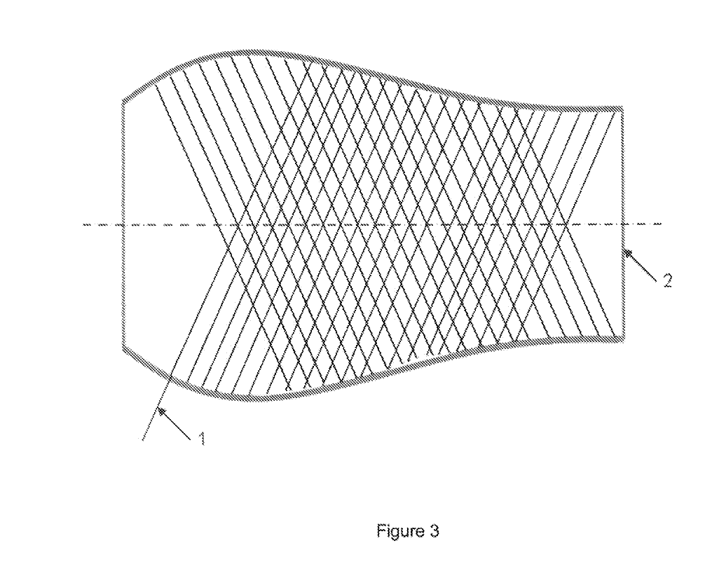

### DETAILED DESCRIPTION

A method according to the invention is used to make a part from a composite material with a metal matrix, such as a turbojet engine nozzle or a nozzle portion, for example.

According to the inventive method, an assembly of fibers 1 intended to make up a reinforcing charge of the composite material with a metal matrix is previously coated with the considered metal alloy or metal.

The fibers 1 can be in several forms and several materials.

Examples of component materials of the fibers 1 were provided above.

The fibers 1 can assume the form of long fibers, woven bedding, strips and charged strips, for example.

The reinforcing fibers 1 are arranged on a preform 2 of the final part.

Long fibers 1 may be positioned by winding on the preform 2.

Short fibers or woven strips may be positioned by stacking on the preform.

The coating of the fibers 1 may be done by passing the fibers in a bath of the desired metal or alloy.

The coated fibers 1 thus positioned on the preform 2, the cohesion of the final structure is ensured by heat treatment enabling the melting and diffusion of the metal elements. This operation is done inside a mold with a shape complementary to the preform 2.

In order to favor contact and ensure good diffusion and homogenization of the metal matrix, the preform 2 is kept in contact against the mold and compression stresses are applied.

As previously explained, the necessary compression stresses are greatly reduced relative to the prior art. The compression stresses can therefore advantageously be applied by the preform 2 itself owing to its heat expansion. To that end, the preform 2 will be made from a material whereof the heat expansion is greater than that of the metal matrix of the part to be formed.

The applicable pressures are determined as a function of the relative geometries and thermal properties of the part and the tools.

In certain cases, a press can replace the differential expansion tools.

The skins of the part made can be stiffened by adding profiles that can be welded by diffusion or brazed during heat treatment of the composite metal matrix material.

To make a skin with holes, the preform 2 may be provided with spurs 3, which may or may not be retractable depending on the geometry of the part, around which the coated fibers 1 can be positioned. Depending on the positioning capacity of the fibers 1, a free placement can suffice to define a space free from fibers 1 between two rows of fibers 1.

For practical reasons, the forming of the part can give rise to a solid skin that will be pierced later, by water jet, laser or punching, for example.

In order to favor the removal of the part on the preform 2 after production thereof, the spurs 3 can be retractable or made from a thermally or chemically soluble material.

Although the invention has been described with one particular embodiment, it is clearly in no way limited thereto and encompasses all technical equivalents of the described means as well as combinations thereof if they are within the scope of the invention.

1. A method for making a part from a composite material with a metal matrix, comprising:
providing, on a preform of the part to be made, at least one assembly of reinforcing fibers, said fibers being previously coated with at least one metal or metal alloy,
heating the assembly to a temperature sufficient for diffusing thmetal particles surrounding the fiber,
after cooling, releasing the part made of the preform and withdrawing the latter.

2. The production method according to claim 1, further comprising a step for pre-coating the fibers.

3. The production method according to claim 1, further comprising a step for compression of the molten metal between the mold and the preform.

4. The production method according to claim 3, wherein the compression step takes place during the heat treatment step.

5. The method according to claim 4, wherein the compression step is done by heat expansion of the preform.

6. The method according to claim 1, wherein at least part of the fibers assume the form of at least one woven strip.

7. The method according to claim 6, wherein the strip comprises particular charges.

8. The method according to claim 1, wherein the preform is provided with spurs so as to make a skin made from a composite material with a perforated metal matrix.

9. A part made from a composite material with a metal matrix, wherein it can be obtained using a method according to claim 1.

10. The part according to claim 9, wherein it is a component part of a turbojet engine nozzle.
